(19) United States
(12) Patent Application Publication
(10) Pub. No.: US 2015/0006651 A1
(43) Pub. Date: Jan. 1, 2015

(54) SYSTEM AND METHOD FOR MANAGEMENT OF IM CONVERSATION HISTORY

(71) Applicant: Avaya Inc., Basking Ridge, NJ (US)

(72) Inventors: Thomas Chmara, Richmond (CA); Jodee Varney, Lincoln, MA (US); Daniel Brisson, Gatineau (CA); Bryn Rahm, Ottawa (CA)

(73) Assignee: Avaya Inc., Basking Ridge, NJ (US)

(21) Appl. No.: 14/270,830

(22) Filed: May 6, 2014

Related U.S. Application Data
(60) Provisional application No. 61/840,860, filed on Jun. 28, 2013.

(51) Int. Cl. H04L 12/58

(52) U.S. Cl. CPC H04L 51/24
USPC 709/206

(57) ABSTRACT

System and method to enable access restriction to a recorded electronic conversation among a plurality of users, the method including: establishing an electronic conversation among at least a first subset of the plurality of users, the first subset comprising an initial membership of the electronic conversation; recording in a conversation history a change in membership of the electronic conversation; transmitting a notification to at least a portion of a current membership of the electronic conversation; associating the notification with membership of the electronic conversation existent at the time the notification is transmitted; recording the notification in the conversation history; relaying a message to at least a portion of a current membership of the electronic conversation; associating the message with membership of the electronic conversation existent at the time the message is relayed; and recording the message in the conversation history.

### CROSS-REFERENCE TO RELATED APPLICATIONS

This application claims the benefit of U.S. Provisional Patent Application Ser. No. 61/840,860, filed on Jun. 28, 2013, the entire content of which is hereby incorporated by reference in its entirety.

### BACKGROUND

1. Field of the Invention

Embodiments of the present invention generally relate to managing access to collaborative online conversations, and, in particular, to a system and method for enforcing permissions when accessing the historical record of a collaborative online conversation.

2. Description of Related Art

Multiparty communication sessions such as conference calls, IM sessions and web chat sessions are well known. Participants are generally allowed to join or drop their individual participation in the multiparty communication session at their discretion. Some communication channels may be able to support more than one communication session at the same time, e.g., a web chat room may be able to support multiple conversation threads concurrently. A participant may be participating in more than one conversation thread.

Existing systems do not adequately support or enforce the separation of conversation threads that share a participant list. Inadequate separation may lead to inappropriate access to information by some participants, information overload by participants, and risking that a participant will miss important information. Some communication applications that support multiparty communications, e.g., XMPP-based clients like Pidgin and others, make inadequate usage of the “Thread Id,” whereby the Messages in a Conversation can be distinguished. Even when multiple conversations are conducted between peers, all messages between the same participants are generally lumped together as though sharing a Thread ID.

Existing systems do not adequately support distribution of messages across systems, risking that a participant will not receive a message if the participant does not have access to a given system at a particular time. Once a participant joins a conversation using one system, it is difficult to transition to another during that same conversation. Additionally, the complete record of an interaction that crosses systems is often distributed between those systems rather than being accessible from a single point.

Therefore, a need exists to provide improved management of a complete conversation through appropriate distribution of messages between systems to ensure a complete record is available, and support and enforcement of separation of different conversations that share some or all participants.

### SUMMARY

Embodiments in accordance with the present disclosure provide a method to enable access restriction to a recorded electronic conversation among a plurality of users, the method including: establishing, by a processor, an electronic conversation among at least a first subset of the plurality of users, the first subset comprising an initial membership of the electronic conversation; recording in a conversation history, the conversation history stored in a database coupled to the processor, a change in membership of the electronic conversation; transmitting a notification to at least a portion of a current membership of the electronic conversation; associating the notification with membership of the electronic conversation existent at the time the notification is transmitted; recording the notification in the conversation history; relaying a message to at least a portion of a current membership of the electronic conversation; associating the message with membership of the electronic conversation existent at the time the message is relayed; and recording the message in the conversation history.

Embodiments in accordance with the present disclosure provide a system to enable access restriction to a recorded electronic conversation among a plurality of users, the system including: a processor configured to establish an electronic conversation among at least a first subset of the plurality of users, the first subset comprising an initial membership of the electronic conversation; a transmitter coupled to the processor, the transmitter configured: to transmit a notification to at least a portion of a current membership of the electronic conversation; and to relay a message to at least a portion of a current membership of the electronic conversation; an association module coupled to the processor, the association module configured to associate: the notification with membership of the electronic conversation existent at the time the notification is transmitted; and the message with membership of the electronic conversation existent at the time the message is relayed; and a recording module configured to record, in a conversation history in a database coupled to the processor: a change in membership of the electronic conversation; the notification; and the message.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a system in accordance with an embodiment of the present invention;

FIGS. 2A-2B illustrate at a relatively higher level of abstraction a process to manage access to a conversation history, in accordance with an embodiment of the present invention;

FIG. 3 illustrates at a relatively lower level of abstraction a process to manage access to and provide a complete record of a conversation history, in accordance with an embodiment of the present invention; and

FIG. 4 illustrates a process to provide transparent interoperability of messaging, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The disclosure will be illustrated below in conjunction with an exemplary communication system. Although well suited for use with, e.g., a system using a server(s) and/or database(s), the disclosure is not limited to use with any particular type of communication system or configuration of system elements. Those skilled in the art will recognize that the disclosed techniques may be used in any communication application in which it is desirable to utilize collaborative online conversation, when some users may be granted limited access to portions of the conversation.

The exemplary systems and methods of this disclosure will also be described in relation to software, modules, and associated hardware. However, to avoid unnecessarily obscuring the present disclosure, the following description omits well-known structures, components and devices that may be shown in block diagram form, are well known, or are otherwise summarized.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, the term “transmitter” may generally comprise any device, circuit, or apparatus capable of transmitting a signal. As used herein, the term “receiver” may generally comprise any device, circuit, or apparatus capable of receiving a signal. As used herein, the term “transceiver” may generally comprise any device, circuit, or apparatus capable of transmitting and receiving a signal. As used herein, the term “signal” may include one or more of an electrical signal, a radio signal, an optical signal, an acoustic signal, and so forth.

The term “computer-readable medium” as used herein refers to any tangible storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

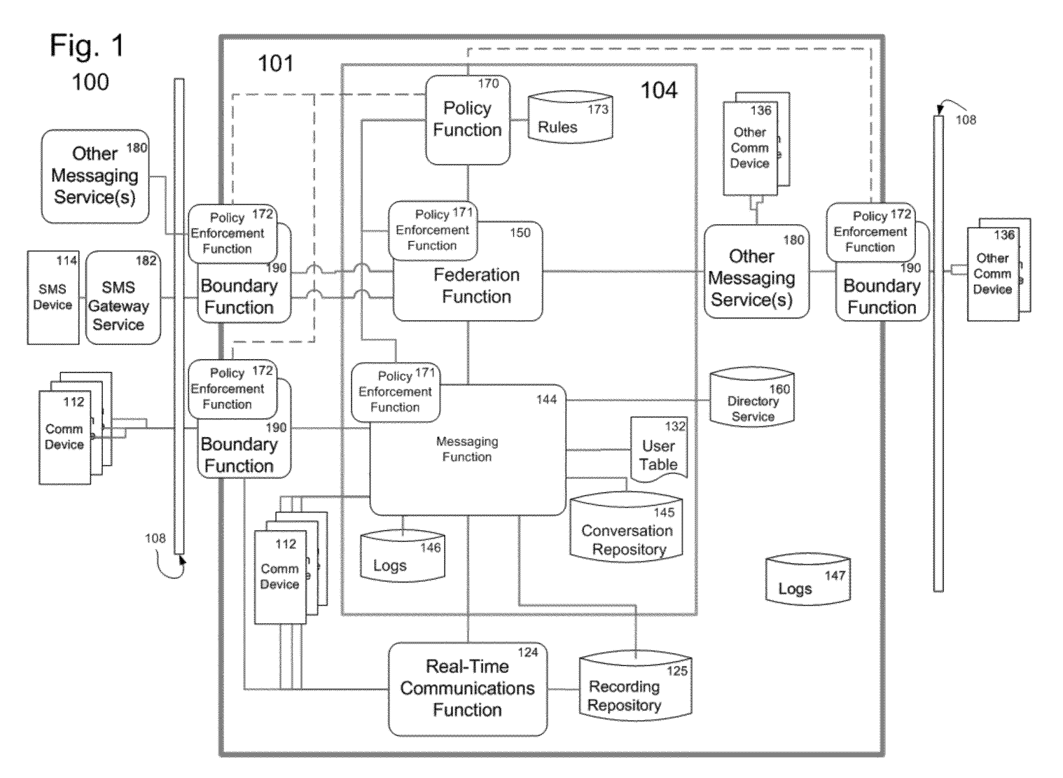

FIG. 1 depicts a communication system 100 according to an embodiment of both the conversation management and the transparent message interop component. The communication system 100 may include an enterprise network 101 that is in communication with one or more communication devices 112, 136, or 414 directly or via an external (untrusted or unsecure or public) network 108, and potentially one or more other messaging or SMS systems 180 or 182. The communication devices 112 or 136 could be internal or external. External devices are generally referred to as “external” because they are either not under the direct control of the enterprise administering the enterprise network 101 or have a decreased level of trust with the enterprise network 101 as compared with communication devices 112 and 136 that are within the enterprise network 101. Exemplary types of external communication devices 112, 414, and 136 include, without limitation, cellular phones, laptops, Personal Computers (PCs), Personal Digital Assistants (PDAs), digital phones, analog phones, and the like.

The communication network 108 may be packet-switched and/or circuit-switched. An exemplary communication network 108 includes, without limitation, a Wide Area Network (WAN), such as the Internet, a Public Switched Telephone Network (PSTN), a Plain Old Telephone Service (POTS) network, a cellular communications network, or combinations thereof. In one configuration, the communication network 108 is a public network supporting the TCP/IP suite of protocols.

The enterprise network 101 may include a boundary device 190 which controls access between elements of network 101 and those of network 108, under control of a policy enforcement function 172. Network 101 may include communications devices 136 and 112, other services such as directory service 160, other messaging services 180, and real-time communications functions 124 with their ancillary components including but not limited to recording repository 125. Network 101 will also include system 104 comprising embodiments of this invention, which includes a messaging function 144, a federation function 150, and a policy function 170, each of which have ancillary components as per FIG. 1 and as will be elaborated on below. Network 101 may include other components unrelated to embodiments of the invention.

Boundary function 190 which is interposed between external and internal networks may perform the functions of firewall, gateway, and policy enforcement within the same or multiple components. Boundary Function 190 may implement user authentication/authorization/administration and user mapping functions. Boundary function 190 may be implemented on the same or different devices or platforms to support different communications paths to SMS gateway service 182, other Messaging service(s) 180, and end-user communications devices 136 and 112 including but not limited to carrying real-time interactions with Real-Time Communications Function 124 and messaging traffic for Messaging Function 144, Federation Function 150, and Other Messaging Services 180.

Messaging function 144 hosts message-based exchanges between the users who employ devices 112, and through a federation function 150 and possibly boundary functions 190 interoperates with SMS gateway service 182 and other messaging service(s) 180 to reach other devices 136 and 414.

Policy operations are embodied in Policy Function 170, based on Rules 173. Policy enforcement of these operations is performed by Policy Enforcement Function 171. Policy enforcement function 172 controlling boundary function 190 behaviors may be controlled by the same Policy Function 170 or by another Policy Function within network 101.

Messaging function 144 may make use of network 101's Directory Service 160 for addressing and/or authentication; and Real-Time Communications Function 124. Messaging function 144 stores Conversation artifacts in Repository 145. Messaging function 144 may store its user information in User Table 132, Directory Service 160, or distribute its user information across the two resources. Operational, security, and audit logs are captured in Logs repository 146 and may be distributed to other log repository(ies) 147 within network 101.

Real-Time Communications Function 124 provides real-time communications services including but not limited to voice, video, web collaboration, and voice and video conferencing within one or more components, and may store recordings of completed real-time communications sessions on Recording Repository 145.

Some or all of the functions depicted in FIG. 1 may be co-hosted and/or co-resident on a single server. The depiction of components in FIG. 1 is generally intended to be a logical depiction of the components of the system 100.

The real time communications function server 124 can include a Private Branch eXchange (PBX), an enterprise switch, an enterprise server, a web conferencing server, a video conferencing server, a voicemail or video-mail server-combinations thereof, or other type of telecommunications system switch or server. The real time communication function server 124 is preferably configured to execute telecommunication or web conferencing or video conferencing functions such as the suite of or Avaya Aura™ applications of Avaya, Inc., including Communication Manager™, Avaya Aura Communication Manager™, Avaya IP Office™, Communication Manager Branch™, Session Manager™, System Manager™, MultiVantage Express™, Scopia Elite MCU, Avaya Aura Collaboration Server, Avaya Aura Messaging Server, CallPilot, Communication Manager Messaging, and combinations thereof. Embodiments herein may refer to real-time communication function server 124 generically as a “session manager” for ease of reference.

Although only a single real-time communications function server 124 is depicted in FIG. 1, two or more real-time communications function servers 124 may be provided in a single enterprise network 101 or across multiple separate networks 101 that are owned and operated by a single enterprise, but separated by a communication network 108. In configurations where an enterprise or an enterprise network 101 includes two or more real-time communications function servers 124, each server 124 may comprise similar functionality or have different functionality. If a server has similar functionality, the server may be provisioned for providing its features to only a subset of all enterprise users. In particular, a first communications server 124 may be authoritative for and services a first subset of enterprise users whereas a second communications server 124 may be authoritative for and services a second subset of enterprise users, where the first and second subsets of users generally do not share a common user.

Additionally, multiple servers 124 can support a common user community. For example, in geo-redundant configurations and other applications where users aren't necessarily bound to a single application server, there may be a cluster of equivalent servers where a user can be serviced by any server in the cluster.

In accordance with at least some embodiments of the present invention, the mapping of user identities within a communication request does not necessarily have to occur at the network boundary device 190. For instance, the mapping between an authoritative server and a user may occur “behind” the network boundary device 190 within the enterprise network 101.

One skilled in the art will also appreciate that a system in accordance with an embodiment of the present invention may include more than one enterprise network 101. For example, a first enterprise network 101 may be devoted to servicing an organization's internal private network behind a firewall, and a second enterprise network 101 may be devoted to servicing an organization's external-facing public network.

As used herein, the term “conversation” refers to a set of messages and events associated with a particular electronic instant-messaging stream of activity, rather than a session-oriented exchange. The messaging stream may encompass more than one topic or message thread. A message thread is a group of messages that may be related by way of topic, authorship, or recipients. A message thread is associated with messages, and with one or more authors or recipients of one or more messages in the message thread. Messages within a message thread may also be associated with a timestamp or other index, which may be used to sort the messages (e.g., chronologically, or by author, etc.).

A user cannot be excluded from any of the messages in the messaging stream while the user is a participant in the conversation. A conversation can be between two participants or more than two participants. Users may open another window for a separate conversation that includes the same or a different set of participants or a sidebar conversation that includes a subset or superset of the participants of the current conversation without affecting the current conversation. The conversation could include event messages that indicate that the instant-messaging stream was escalated to a session-oriented communication modality such as a voice call, conference call, video call, web conferencing or collaboration session. Escalation Event messages can include the timestamps, reference to any session records or recordings, files transferred, etc. Escalation Event messages are visible to anyone on the participant list at the time of the escalation even if they could not participate in the escalation session.

A conversation may begin with a first user at an external communication device 112 communicating through communication network 108 with a second user at another external communication device 112. Next, one of the current users may invite additional users to join the conversation, creating an enlarged group of users. Additional users are individually invited, rather than being invited through, e.g., a public or semi-public announcement of a web address, a public or semi-public call-in number, or the like. A semi-public announcement or call-in number may be an information that is known within a predetermined group such as company employees, including employees without a direct interest in the subject matter, but not known to the general public outside the predetermined group. The enlarged group of users will continue collaborating. At some later point, one or more of the enlarged group of users may drop off or otherwise discontinue their participation in the conversation, e.g., choose to leave, be removed by a moderator or session organizer, be removed for inactivity, or the like. For example, a user may be excluded from sensitive discussion topics that do not require their participation, or a user may be excluded if their participation has become disruptive. The participant list is updated whenever a user joins or leaves/removed. The removal from the participant list is of the nature that the removed user will not have access now or in the future to communications that occur in the communication session during the time period in which the user is not part of the participant list.

Messaging clients commonly support announcement of new users joining a conversation and users dropping a conversation. However, once a user has departed the conversation but later returns to the conversation, the conventional art lacks a mechanism to retrieve earlier messages for that returning participant, or to limit the view of returning participants only to messages or conversation events for which the user was a member of the participant list of the conversation. Conventional messaging clients provide all messages that include the same participant list, regardless of conversation identity or thread identity,

The conventional art is unable to provide a complete record of all messages in a conversation if the messages were created using a different messaging client, or if the messages were lost or discarded from this client, or if the messages were created using a different messaging system. Although some messaging clients of the known art may support escalation of a conversation to a different modality (e.g. escalating an instant messaging interaction to a voice call, or a voice call to a video call), such known solutions do not integrate a record of modality changes (e.g., escalations) in the shared record of the interaction. A record of modality may be important because the record of modality provides a history of communication events, e.g., sending a message, receiving message in response to the sent message, initiating a telephone call to follow up on the received message, and so forth.

The known art commonly practices client-side retention of messages, which would require manual correlation across multiple entries in a client's local store of messages in order to reconstruct interrupted message threads. Such manual methods are error-prone, and are inconsistent across a variety of user clients. In contrast, embodiments in accordance with the present disclosure provide server-side retention of messages, notices and events.

At some later point in time, a user who had been dropped may be invited to rejoin the conversation, for example after discussion of a sensitive agenda topic has concluded. When such a user rejoins the session, it may be difficult for the rejoining user using client-side retention to reconstruct message threads and conversation flows, particularly if the user's application software was completely shut down. In this circumstance, it can be difficult to retrieve the earlier parts of the various message threads, and the context of the message threads may be affected by communications that occurred during the time period in which the user was disconnected from the communication session.

As known in the present art, if a user is “invited back” to use a messaging systems, the user is placed into a different conversation than the conversation that they had left. Any previous messages from the user's previous session may be retrievable, but the system will not inform the user that the messages are related to the user's messages from previous sessions. Therefore, searching through messages is disjoint and extremely difficult for a user who left and later rejoined the conversation, especially if other participants in the conversation also left and later rejoined, causing conversation participants to be different over time.

Embodiments in accordance with the present invention do not suffer the shortcoming of the known art discussed above, because retrieving the history of a conversation delivers to a user only messages and event notifications that the user had access to while they were a participant, without delivering messages and event notifications that the user is not otherwise privy to.

Embodiments in accordance with the present invention provide improved security, assurance, and confidentiality in exchanging real-time electronic messages such as instant messages, web chats, and the like, as part of a conversation. Embodiments use server-side recording and client-side access in order to enforce access privileges by users to only the messages and events for which the user was a participant.

Embodiments in accordance with the present invention further provide an ability for re-association, i.e., an ability to re-invite a user to a conversation, along with an ability to access and view a historical view of all interactions for which the user had been a participant from this and previous times that the user had been a participant. The historical view of previous interactions is server-managed and thus not user-changeable. The historical view is consistent across any devices that are attached to the system during the user's participation, and forms part of the historical record of their interaction in the conversation, for ease of later search and/or review. The consistent historical view provides assurance to other participants that the re-associated user can view only the interactions that the user is authorized to access, without access to interactions during periods of time when the re-associated user had departed from the conversation.

If a user leaves a conversation, or is dropped, flagged, or otherwise forced out, the user is not brought back into the conversation without clear and obvious departure and re-association markers in the conversation history. All of the participants in the conversation (i.e., the dropped, flagged, or otherwise forced out user, as well as all other participants who are continuing the conversation), and the record of the conversation, have explicit mention of the departure and/or re-association of users.

Embodiments in accordance with the present invention embed into the conversation history a marker to indicate when the membership of the conversation changes, and an indication of the changed membership. The marker may be in the form of an indication that is detectable within the information-bearing channel (e.g., a textual notification within an IM chat session), or as an out-of-band notification such as in a control channel or in metadata. The departure, joining, or rejoining of any participant to a conversation will trigger a marker to note the event. By use of such markers, embodiments are able to put a returning user right back into a same message thread upon re-association with the conversation.

Embodiments in accordance with the present invention can also present any other events that occur as part of the conversation, including any escalations to a real time interaction session that occurred as part of the conversation. This includes escalation to call, escalation to videoconference, escalation to web conference. The conversation history can present the marker of the initiation of this event, completion of this event, and reference to any other information associated with the event such as a call recording.

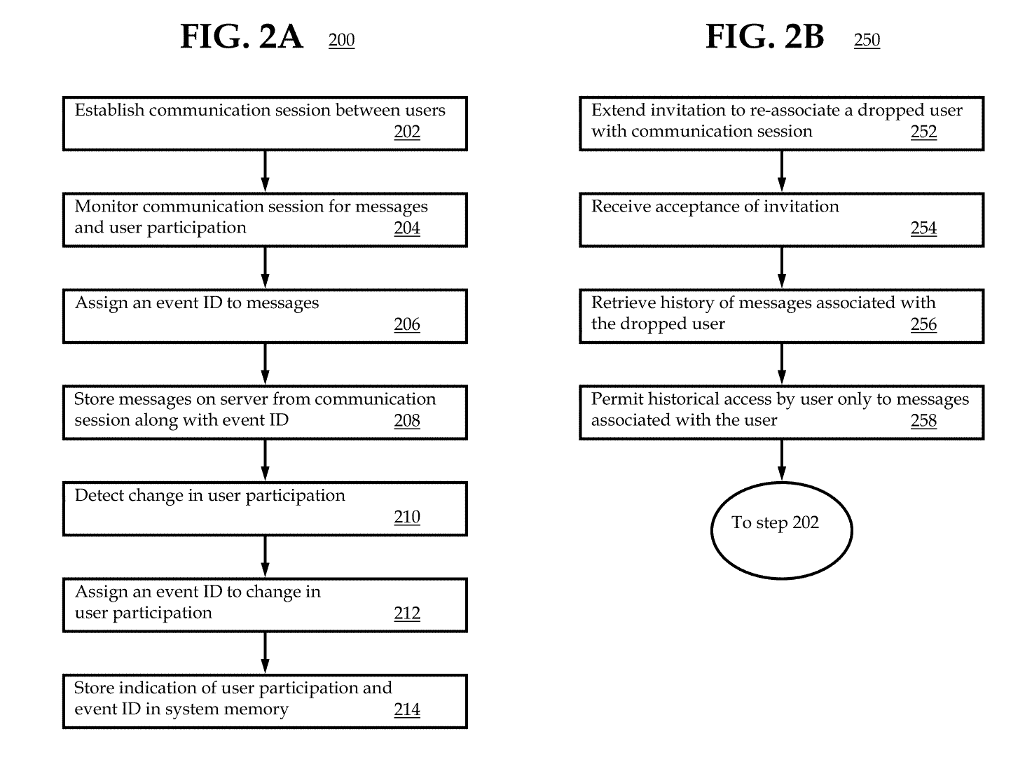

FIG. 2A illustrates at a high level of abstraction a process 200 to conduct a multiparty conversation, in accordance with an embodiment of the invention. Process 200 begins at step 202, at which a communication session is established between users. The users typically will be using a communication device such as external communication devices 112. Devices 112 will be connected through communication network 108. The communication session is managed by a server within enterprise network 104, and more particularly by a server in enterprise network 104.

Next, process 200 proceeds to step 204, at which the communication session established at step 202 is monitored. More particularly, the occurrence of messages (i.e., that a message is sent or received) is monitored, and the set of users participating in the communication session at the time of each message is monitored. Optionally, the content of messages may be analyzed (e.g., keyword detection) to try to infer a thread to which the message belongs. Messages may be viewed and processed by use of the inferred message thread.

Next, process 200 proceeds to step 206, at which a server in enterprise network 104 assigns an event ID to each of the messages. Next, process 200 proceeds to step 208, at which the messages and their associated event ID are stored on a database accessible to a server, such as database 145.

Next, process 200 proceeds to step 210, at which a server in enterprise network 104 detects a change in the set of users who are participating in the communication session. Participation includes both an active participation (e.g., user is contributing messages) and a passive participation (e.g., user only receives messages, without contributing messages). Users may be identified by the login/password used when initially joining the session or initially being authorized to join the session.

Next, process 200 proceeds to step 212, at which a server in enterprise network 104 assigns an event ID to the detected change in the set of participating users.

Next, process 200 proceeds to step 214, at which a server in enterprise network 104 stores in database 145 an indicator of the change in user participation and the associated event ID. Examples of the indicator of the change in user participation may include a list of the participating users, or just the change in the list of participating users.

In contrast to the known art, embodiments in accordance with the present invention, by storage of event IDs and message IDs, will provide sufficient contextual information such that a re-associated user is placed back into the same message thread upon re-association.

FIG. 2B illustrates at a high level of abstraction a process 250 to re-associate a user with a conversation, such that the re-associated user has access to previous communications in which the re-associated user had participated, and not to any previous communications in which the re-associated user had not participated. Process 250 begins at step 252, at which an invitation is extended to a previously-dropped user, to have the user rejoin or re-associate with the communication session. For example, a conference participant using an external communication terminal 112, who has sufficient permission or authority to invite users (e.g., a conference moderator or the like), may extend the invitation to a user. The user receiving the invitation is assumed, without loss of generality, to be using another external communication terminal 112.

Next, at step 254, a server in enterprise network 104 receives from the user an indication that the user has accepted the invitation to re-associate with the conversation.

Next, at step 256, a server in enterprise network 104 retrieves from database 145 the historical messages that the re-associated user had participated in previously.

Next, at step 258, a server in enterprise network 104 permits the re-associated user to have access to the historical messages in which the user had participated in the past. Optionally, the messages may be organized according to message thread.

At the conclusion of process 250, the conversation may proceed as previously discussed. More particularly, at the conclusion of process 250, control may transition to step 202 of process 200 so that the conversation may continue with the participation of the re-associated user.

Embodiments in accordance with the present invention provide improved security, assurance, and confidentiality when participating in electronic communications, in particular multiparty conferences, instant messages, and the like. Embodiments provide server-side recording of the electronic communications, and enforce client-side access to only the messages and events for which the user was a participant. Participants can depart a conversation on their own initiative, or in response to being ejected or forced out of the conference. In either case, the user no longer has access to the record of events for that conversation after the departure of the user.

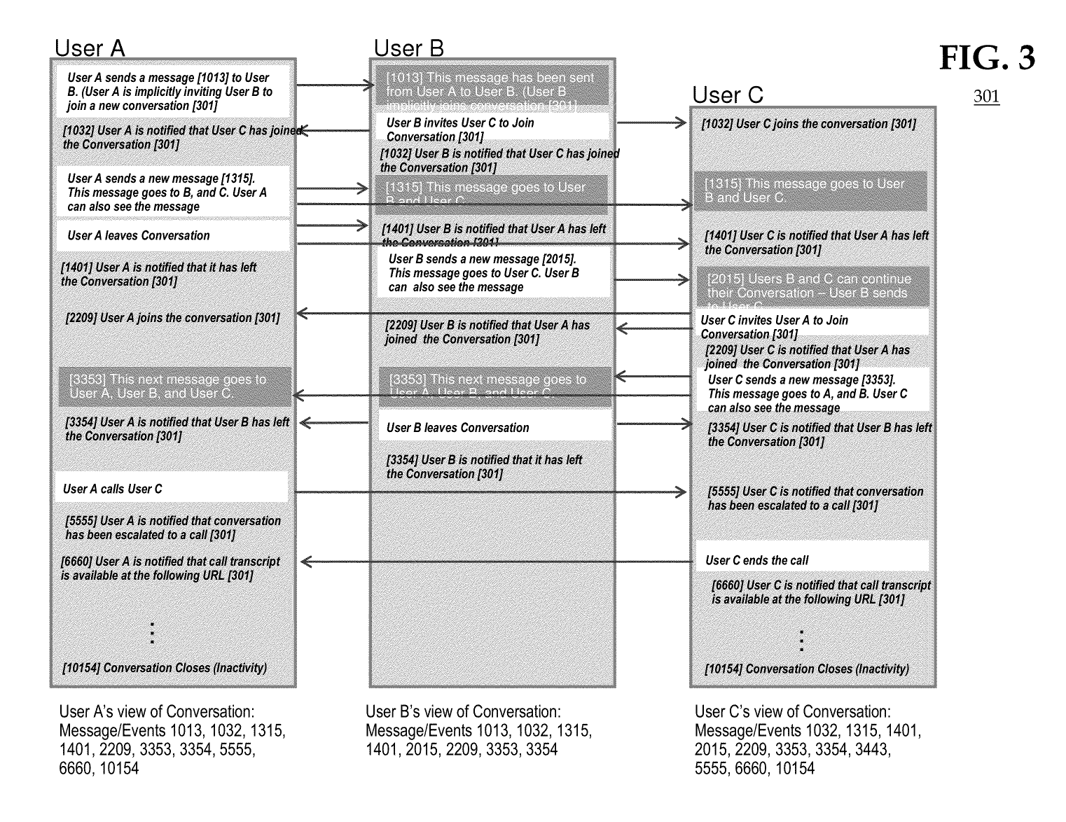

FIG. 3 illustrates at a relatively lower level of abstraction an exemplary scenario to conduct a multiparty conversation 301 among User A (left column), User B (center column) and User C (right column), in accordance with an embodiment of the invention. FIG. 3 illustrates actions performed by a respective User A, B or C in white, status events received by respective User A, B or C in light gray and messages received by respective User A, B or C in a darker gray. Each message and event also includes an identifier (“ID”), which is illustrated in FIG. 3 as a bracketed number. The ID number for a message and/or event must be unique within a conversation and will be the same among users when designating the same message or event for all participating users of the conversation. Note the actual message content has not been included in FIG. 3 for ease of reading.

Referring again to FIG. 3, User “A”, by sending an initial message 1013 to User “B” via a server in enterprise network 104, is effectively creating a new conversation, i.e., conversation 301. The server presents to Users “A” and “B” a first message display 1013.

FIG. 3 assumes that users must be invited to a conversation, i.e., users cannot join a conversion only by their own volition, i.e., not by only their own choice. Conversation 301 illustrates that embodiments in accordance with the present invention announce the arrival and/or departure of a user to all other participating users. Conversation 301 illustrates that embodiments include a limiting mechanism in the server that assures that users see events and the content of a conversation only during periods of time during which the user had been a participant of the conversation. This limiting mechanism protects the confidentiality of communications that occur during periods of time when the user was not an active participant in the conversation. The limiting mechanism also acts to shield users from interruption by unwanted content or content that is no longer of interest to them.

Conversation 301 supports a presentation to users of a consistent view of all the user's conversations when using any of the clients used by the user. When the user uses a client device to join the conversation, the newly-connected client devices are synchronized to the user's conversation history by a server in enterprise network 104.

For example, referring to conversation 301, message 1013 is visible to the affected Users A and B, but not to User C who is not yet part of the conversation. Event 1032 and message 1315 affect each participating User (A, B and C) and are seen by each user. After User A leaves the conversation and all users are notified by way of event 1401, User A no longer sees message 2015. Even after User C invites User A to rejoin the conversation, and notice of this event is disseminated to all participants by way of event 2209, User A cannot display message 2015.

At the conclusion of conversation 301, User A's view of conversation 301 includes messages and/or events 1013, 1032, 1315, 1401, 2209, 3353, 3354, 5555, 6660 and 10154. User B's view of conversation 301 includes messages and/or events 1013, 1032, 1315, 1401, 2015, 2209, 3353 and 3354. User C's view of conversation 301 includes messages and/or events 1032, 1315, 1401, 2015, 2209, 3353, 3354, 3443, 5555, 6660 and 10154.

Embodiments further provide to a returning user a view of a conversation that includes substantially all of the interactions in which the user had been previously participating. The view is server-managed and thus is not user-changeable. The provided view is consistent across all of the user's devices during the user's participation. Based on the most recent list of active participants in a conversation, the view also provides the user the ability to tell who will be the recipient of a subsequent message. Upon retrieving a historical view, the user will only see the messages associated with the period in which they were a participant in the conversation.

Embodiments in accordance with the present invention also provide that the events captured in the conversation include escalations to a real-time session (e.g., to a voice, video, or other type of interaction), a record of who was invited to the escalated session, and so forth. The record of events may be enhanced by other contextual artifacts such as permitting access to a recording or transcript (or any other artifacts) of the real-time session.

Although email headers of the known art may include a “References:” header that may be used to trace through the list of emails that had been exchanged, such a mechanism fails to include a way to exclude users who may have dropped and reestablished membership from having unauthorized access to messages that were exchanged while the user was not a member of the conversation. For example, such users will be able to determine the number of messages and the message IDs that were exchanged while the user was excluded from the conversation.

Users of the known art who are concurrently working in multiple messaging systems, and thus have different addresses or screen names, are seen by recipients of their messages as being different users. Conversations started in one system are not fully visible in, or supported by, the other messaging systems that the user may be using. Users must return to the environment in which they created the messaging thread to review the messaging thread in its entirety and continue contributing to it.

The known art includes limited examples of address rewriting at various levels of protocol interaction. For example, routers, firewalls, gateways and proxies are able to rewrite addresses, but the capability is typically limited to a one-for-one substitution (i.e. an address, often an internal address, is rewritten to another address, often an external address). Some of the known art performs email address rewriting (e.g., ‘user5535@internal.example.com” becomes “JohnDoe@example.com”). However, both addresses refer to the same user's account on the same system or environment.

In contrast to known art such as group addresses (e.g., a Usenet mailing list), other mailing lists (e.g., LinkedIn Groups), remailers, and Unix/Linux “.forward” capability, embodiments in accordance with the present invention allow usage of multiple addresses such that the usage is transparent to all other participants. Embodiments thus provide a consistent conversation view to any conversation participants. Embodiments also provide a complete and consistent historical view of a conversation to any users of the embodiments.

Embodiments in accordance with the present invention keep track of the user's other messaging system address(es) and any policy or policies associated with distributing messages to other addresses.

Embodiments in accordance with the present invention improve over the known art by coupling address rewriting with the managed distribution of traffic to the user's other messaging systems in order to provide a single identity of the user to other participants in a conference. Embodiments thus facilitate a user's ability to continue using any available messaging client or system without changing the apparent source visible to other conference participants.

Embodiments in accordance with the present invention couple similar address rewriting with a managed distribution of traffic to other systems used by a user.

Embodiments in accordance with the present invention allow a user to interact with a messaging system from a primary system and/or from one or more secondary systems that are associated with the user's account on the first system in a transparent manner so that other users aren't aware of the distinction. This is useful when a user is transitioning between systems, or when the user uses a different system than usual because of certain devices or environments available on the different system.

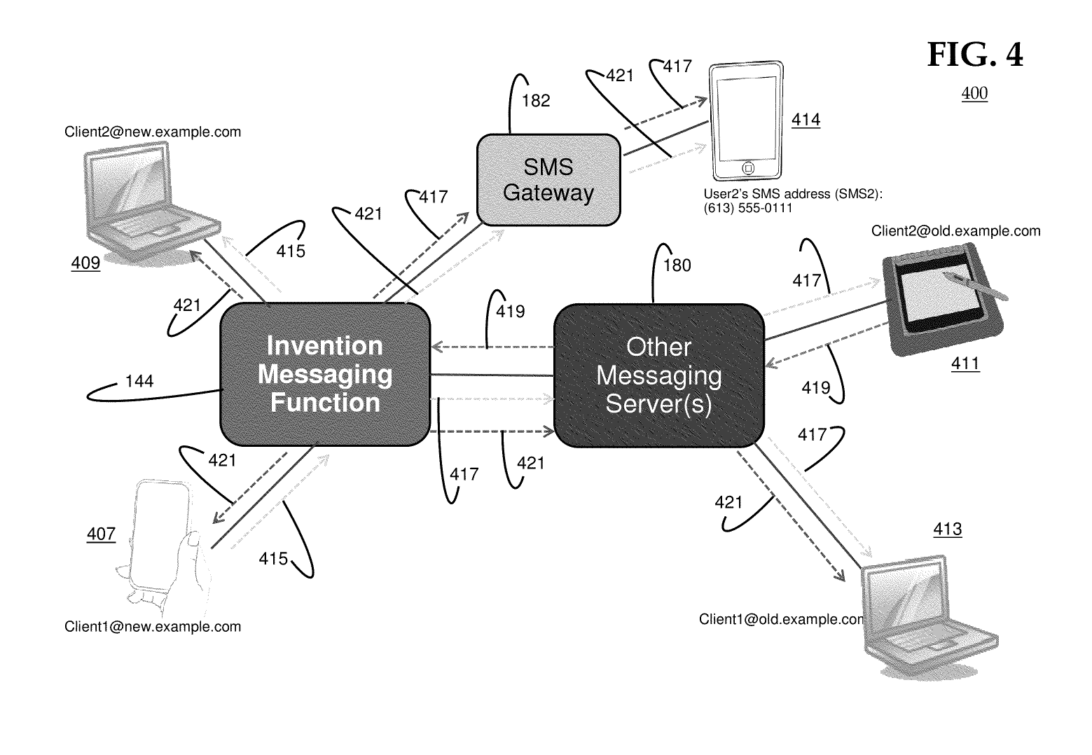

FIG. 4 illustrates a system 400 in accordance with an embodiment of the present invention. System 400 includes a Messaging Function server 144 in direct communicative contact with Messaging Function clients 407 and 409. Messaging Function server 144 may be implemented as server 144 of FIG. 1, and clients 407 and 409 may be implemented as communication terminals 112 of FIG. 1. Messaging Function server 144 is also in communicative contact with Other Messaging Server(s) 180 and SMS Gateway(s) 182. Other Messaging Server(s) 180 is in communicative contact with Other Messaging Server clients 411 and 413. Clients 411 and/or 413 may be implemented as, e.g., communication devices 136 of FIG. 1. SMS Gateway(s) 182 is in communicative contact with SMS device 414. Messaging clients 409 and 411, and SMS device 414 are all associated with User “B”.

All of a user's addresses associated with Messaging Function server 144 are “Primary Addresses.” All of a user's addresses associated with Other Messaging Server(s) 180 and SMS Gateway(s) 182 are a user's “Secondary Addresses”. Users associated with Messaging Function server 144 can have multiple clients all associated with their “Primary Address”. Messaging Function server 144 is populated with a user's desired “Secondary Addresses”. A Conversation's participant list will use the user's primary address, and the Messaging Function server 144 is responsible for ensure the Messages associated with a Conversation are appropriate distributed to any known Secondary addresses. User “A” is associated with Messaging Function client 407 (associated with User “A” primary address) and Other Messaging Server client 413 (associated with User “A” secondary address). User “B” is associated with Messaging Function client 409 (associated with User “B” primary address), Other Messaging Server client 411 (associated with User “B” secondary address), and SMS device 414 (associated with User “B” secondary address).

Operation of system 400 may begin when Messaging Function client 407 sends message 415 to User “B”. Messaging Function server 144 distributes the message to Messaging Function client 409 and transparently copies message 415 as needed to all known secondary addresses associated with client 407 and 409. The copied message 417 is sent on to Other Messaging Server(s) 180 and/or SMS Gateway(s) 182 as needed for distribution to clients 411, 413, and 414.

Next, the user of Other Messaging client 411 may decide to respond to message 417, by way of message 419.

Messaging Function server 144 receives message 419. Messaging Function server 144 makes a copy of the received message 419. This copy is message 421. Messaging Function server 144 distributes message 421 per one of the options for managing the ongoing distribution that ensures message 421 is distributed to all known client addresses while preventing clients from receiving multiple copies.

System 400, when operated in a manner compatible with the description above, provides and enforces proper roster management. For example, each participant would be identified to other users only with the user's preferred address, e.g., other participants do not have to remember that Client1@new.example.com is the same as Client1@old.example.com and/or User9953@frozzbozz.org. Each participant would be listed only once, rather than separately for each alias. All clients receive all traffic regardless of where contributions have come from/gone to with proper attributions. Furthermore, because the Messaging Function server 144 receives all messages that are part of the conversation, regardless of the system on which the conversation's message was generated, the Messaging Function server 144 is thus able to maintain a complete record of a conversation.

Embodiments in accordance with the present invention perform message reflection so that a user may transparently move between different messaging clients or different messaging environments. Other participants of the interactions would be unaware that the user is changing messaging clients or messaging environments. The user would receive a full record of the conversation's exchanges at each messaging client/environment, facilitating seamless interaction in conversations subject to the capabilities supported by the messaging client or environment. If video messages are supported by one messaging client or environment but not another messaging client or environment, then those messages will not be available in the more-limited environment, but the user will have access to the more-featured content on return to a more full-featured client or environment. This process will be seamless to other participants.

To provide this seamless transparency, embodiments in accordance with the present invention forward received messages to all of the user's desired and/or known secondary addresses on one or more other systems without user intervention, so that a user's messages are received on both primary and secondary systems. The forwarding may be based on the user data that is provisioned into the system. The user data may include any alternate addresses used by each user. Where a user responds to messages from the primary system, these responses are likewise forwarded to the secondary system(s); there is no guarantee of address transparency here (the user is aware these came from their primary system) as the transparency is not important. Messages sent or posted by the user from a secondary system are received by the primary server and are the source address is rewritten to appear to originate from the primary system and are propagated to all other participants in the messaging session including that user's instance on the primary system.

Embodiments in accordance with the present invention are able to manage the addition or deletion of other destination addresses, while providing copies of messages to the user's authorized destination addresses, such that a complete view of message threads is viewable from any of the user's destination addresses, and sent messages are seen by other users as coming from a single origination address for the user.

Embodiments of the present invention include a system having one or more processing units coupled to one or more memories. The one or more memories may be configured to store software that, when executed by the one or more processing unit, allows practice of embodiments disclosed herein, at least by use of processes described herein, including at least in FIG. 2A-FIG. 4, and related text.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

What is claimed is:

1. A method to enable access restriction to a recorded electronic conversation among a plurality of users, comprising:
establishing, by a processor, an electronic conversation among at least a first subset of the plurality of users, the first subset comprising an initial membership of the electronic conversation;
recording in a conversation history, the conversation history stored in a database coupled to the processor, a change in membership of the electronic conversation;
transmitting a notification to at least a portion of a current membership of the electronic conversation;
associating the notification with membership of the electronic conversation existent at the time the notification is transmitted;
recording the notification in the conversation history;
relaying a message to at least a portion of a current membership of the electronic conversation;
associating the message with membership of the electronic conversation existent at the time the message is relayed; and
recording the message in the conversation history.

2. The method of claim 1, further comprising:
rejoining a returning user to the electronic conversation;
recording, in the database, a change in membership of the electronic conversation;
identifying a portion of a conversation history associated with the electronic conversation, wherein the portion was generated while the membership of the electronic conversation included the returning user;
retrieving, by the processor from the memory, the identified portion of the conversation history; and
presenting only the identified portion of the conversation history to the returning user.

3. The method of claim 1, further comprising:
receiving, by a receiver coupled to the processor, a request to add a requested user to the electronic conversation;
transmitting an invitation to the requested user;
receiving an acceptance from the requested user;
joining the requested user to membership in the electronic conversation;
recording, in the database, a change in membership of the electronic conversation;
transmitting a notification to at least a portion of a current membership of the electronic conversation; and
recording the notification in the conversation history.

4. The method of claim 1, further comprising:
ending participation by an identified user in the electronic conversation;
removing the identified user from membership in the electronic conversation;
recording, in the database, a change in membership of the electronic conversation;
transmitting a notification to at least a portion of a current membership of the electronic conversation; and
recording the notification in the conversation history.

5. The method of claim 1, further comprising:
receiving, by a receiver coupled to the processor, a message from one of the plurality of users;
determining, by the processor, an electronic conversation associated with the received message;
retrieving a current membership of the determined electronic conversation;
transmitting the received message to the current membership of the electronic conversation; and
storing the message in the conversation history.

6. The method of claim 1, wherein the conversation history further comprises a record of escalations to real time interaction sessions.

7. The method of claim 1, wherein the conversation history further comprises a record of de-escalations from real time interaction sessions.

8. The method of claim 1, wherein the conversation history further comprises identification of documents shared during the real time interaction.

9. The method of claim 1, wherein the conversation history further comprises an audio/visual recording of the real time interaction.

10. The method of claim 1, further comprising: managing distribution of the message to secondary addresses of a user.

11. The method of claim 10, further comprising:
managing secondary addresses for the users associated with a primary address;
disseminating the message to secondary addresses of the user; and
disseminating responses from the secondary addresses to at least a portion of the current membership of the electronic conversation, without revealing an identity of the secondary addresses.

12. A system to enable access restriction to a recorded electronic conversation among a plurality of users, comprising:
a processor configured to establish an electronic conversation among at least a first subset of the plurality of users, the first subset comprising an initial membership of the electronic conversation;
a transmitter coupled to the processor, the transmitter configured: to transmit a notification to at least a portion of a current membership of the electronic conversation; and to relay a message to at least a portion of a current membership of the electronic conversation;
an association module coupled to the processor, the association module configured to associate: the notification with membership of the electronic conversation existent at the time the notification is transmitted; and the message with membership of the electronic conversation existent at the time the message is relayed; and
a recording module configured to record, in a conversation history in a database coupled to the processor: a change in membership of the electronic conversation; the notification; and the message.

13. The system of claim 12, wherein the processor is further configured to:
rejoin a returning user to the electronic conversation;
identify a portion of a conversation history associated with the electronic conversation, wherein the portion was generated while the membership of the electronic conversation included the returning user;
retrieve the identified portion of the conversation history; and
present only the identified portion of the conversation history to the returning user, and
wherein the recording module is further configured to record, in the database, a change in membership of the electronic conversation.

14. The system of claim 12, further comprising:
a receiver coupled to the processor, the receiver configured to receive:
a request to add a requested user to the electronic conversation; and
an acceptance from the requested user;
wherein the transmitter is further configured to transmit:
an invitation to the requested user; and
a notification to at least a portion of a current membership of the electronic conversation;
wherein the processor is further configured to join the requested user to membership in the electronic conversation; and
wherein the recording module is further configured to record:
a change in membership of the electronic conversation; and
the notification in the conversation history.

15. The system of claim 12:
wherein the processor is further configured:
to end participation by an identified user in the electronic conversation; and
to remove the identified user from membership in the electronic conversation;
wherein the recording module is further configured to record:
a change in membership of the electronic conversation; and
the notification in the conversation history; and
wherein the transmitter is further configured to transmit a notification to at least a portion of a current membership of the electronic conversation.

16. The system of claim 12, further comprising:
a receiver coupled to the processor, the receiver configured to receive a message from one of the plurality of users;
wherein the processor is further configured:
to determine an electronic conversation associated with the received message;
to retrieve a current membership of the determined electronic conversation; and
to store storing the message in the conversation history; and
wherein the transmitter is further configured to transmit the received message to the current membership of the electronic conversation.

17. The system of claim 12, wherein the conversation history further comprises a record of escalations to real time interaction sessions.

18. The system of claim 12, wherein the conversation history further comprises a record of de-escalations from real time interaction sessions.

19. The system of claim 12, wherein the conversation history further comprises identification of documents shared during the real time interaction.

20. The system of claim 12, wherein the conversation history further comprises an audio/visual recording of the real time interaction.

21. The system of claim 12, wherein the processor is further configured to manage distribution of the message to secondary addresses of a user.

22. The system of claim 12, wherein the processor is further configured:
to manage secondary addresses for the users associated with a primary address;
to disseminate the message to secondary addresses of the user; and
to disseminate responses from the secondary addresses to at least a portion of the current membership of the electronic conversation, without revealing an identity of the secondary addresses.
